(19) United States
(12) Patent Application Publication
(10) Pub. No.: US 2016/0233686 A1
(43) Pub. Date: Aug. 11, 2016

(54) POWER MANAGEMENT UNIT AND POWER MANAGEMENT METHOD

(71) Applicant: PANASONIC INTELLECTUAL PROPERTY MANAGEMENT CO., LTD., Osaka-shi, Osaka (JP)

(72) Inventors: JUNSHI YOSHIDA, Osaka (JP); TAKASHI NAKABAYASHI, Osaka (JP); KOICHI KUBOYA, Osaka (JP); YUJI OSUMI, Nara (JP); HIROSHI SHIMOSATO, Osaka (JP); TAMAKI IWASAKI, Osaka (JP); SEIICHI UNO, Osaka (JP)

(21) Appl. No.: 15/023,065

(22) PCT Filed: Sep. 22, 2014
(86) PCT No.: PCT/JP2014/004836

§ 371 Date: Mar. 18, 2016

Related U.S. Application Data
(60) Provisional application No. 61/886,424, filed on Oct. 3, 2013.

(51) Int. Cl. H02J 4/00; H04L 29/08

(52) U.S. Cl. CPC H02J 4/00; H04L 67/1002

(57) ABSTRACT

A power management unit includes a part that transmits a first information data related to a first device for creating, consuming, or accumulating first energy and a second information data related to a second device for creating, consuming, or accumulating second energy to a server. The power management unit further includes a part that receives control data for controlling the first and second devices from the server, and a part that transmits the control data to the first device and the second device. Further, a power management method transmits the first information data and the second information data from the power management unit to the server. Furthermore, the power management method transmits control data for controlling the first device and the second device from the server to the power management unit, and transmits the control data from the power management unit to the first device and the second device.

### TECHNICAL FIELD

The present disclosure relates to a power management unit and a power management method.

### BACKGROUND ART

As conventional power management, for example, Patent Literatures 1 to 4 are disclosed. Patent Literatures 1 to 4 disclose power management constituted by a single type of device.

### CITATION LIST

### Patent Literature

PTL 1: Japanese Translation of PCT Publication No. 2013-523060
PTL 2: Unexamined Japanese Patent Publication No. 2012-73740
PTL 3: Unexamined Japanese Patent Publication No. 2011-186721
PTL 4: Unexamined Japanese Patent Publication No. 2001-5543

### SUMMARY OF THE INVENTION

A power management unit in accordance with the present disclosure has a part that transmits first information data related to a first device for creating, consuming, or accumulating first energy and second information data related to a second device for creating, consuming, or accumulating second energy to a server. Further, the power management unit has a part that receives control data for controlling the first device and the second device from the server, and a part that transmits the control data to the first device and the second device.

A power management method in accordance with the present disclosure is a way of transmitting first information data related to a first device for creating, consuming, or accumulating first energy and second information data related to a second device for creating, consuming, or accumulating second energy from a power management unit to a server. The power management method is a way of further transmitting control data for controlling the first device and the second device from the server to the power management unit, and transmits the control data from the power management unit to the first device and the second device.

As above, the information related to multiple types of devices is controlled to utilize energy efficiently.

### BRIEF DESCRIPTION OF DRAWINGS

FIG. 1 is a conceptual diagram of the entire power management system in an exemplary embodiment.

FIG. 2 is a conceptual diagram of a device group of the power management system in the exemplary embodiment.

FIG. 3 is a block diagram of the power management system in the exemplary embodiment.

FIG. 4 is a block diagram of a power management system in a first variation of the exemplary embodiment.

FIG. 5 is a block diagram of a power management system in a second variation of the exemplary embodiment.

FIG. 6 is a block diagram of a power management system in a third variation of the exemplary embodiment.

FIG. 7 is a view showing a data configuration in the first variation of the exemplary embodiment.

FIG. 8 is a view showing a data configuration in the second variation of the exemplary embodiment.

FIG. 9 is a view showing another type of data configuration in the second variation of the exemplary embodiment.

FIG. 10 is a schematic view of a solar panel unit in a first reference.

FIG. 11 is a schematic view of a solar panel unit in a second reference.

### DESCRIPTION OF EMBODIMENT

Conventionally, power management using a single type of device is disclosed. However, power management using multiple types of devices is not disclosed. Thus, the objective of the present disclosure is to provide a power management unit and a power management method that utilize energy efficiently by controlling information related to multiple types of devices.

Hereinafter, an exemplary embodiment of the present disclosure will be described in detail with reference to the drawings. Note that, in figures, the assignment of reference numerals to the same part is omitted, and the description thereof is omitted as necessary. Further, an exemplary embodiment, which indicates an example of preferable embodiments, is not limited to their configuration or shape. Furthermore, respective underlying technologies described in the exemplary embodiment can be combined conveniently if not producing inconsistency.

### EXEMPLARY EMBODIMENT

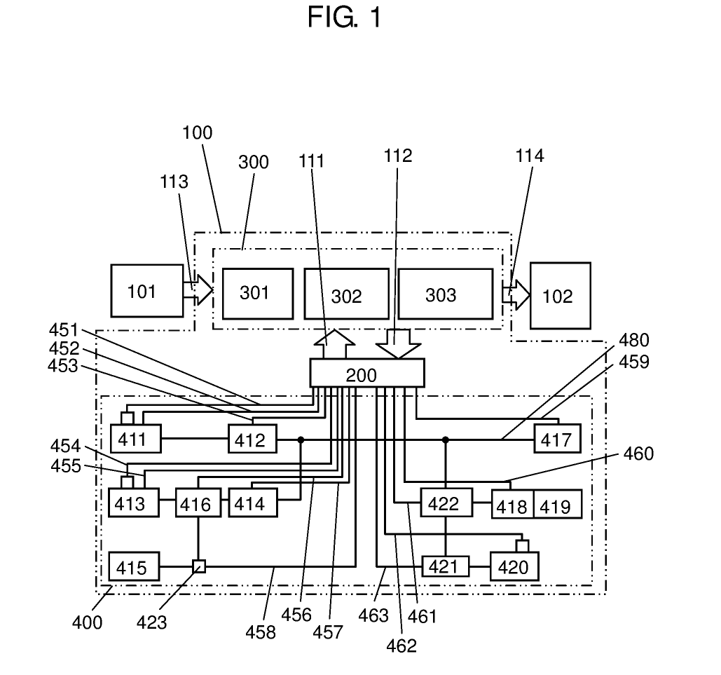

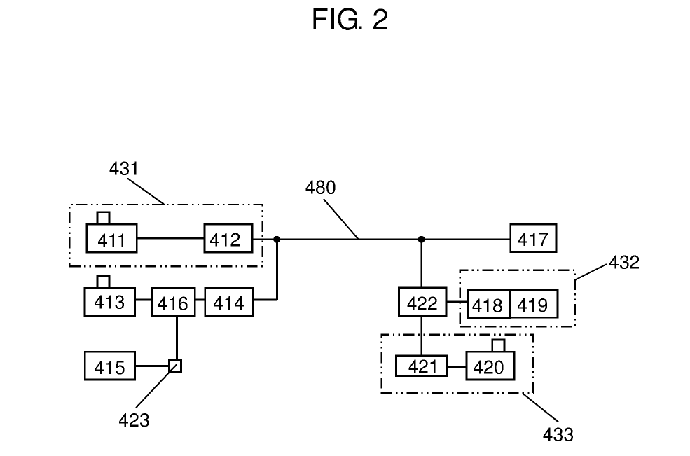

FIG. 1 shows a concept of a power management system in accordance with an exemplary embodiment of the present disclosure. FIG. 2 is a conceptual diagram of a device group of the power management system in the exemplary embodiment. FIG. 2 is a view showing device group 400 and power grid 480 extracted from FIG. 1. The respective devices are connected as shown in FIG. 2.

Firstly, the entire concept of power management system 100 will be described.

Power management system 100 has power management unit 200, server 300, and device group 400. Power management unit 200 transmits and receives data to and from device group 400, and transmits and receives data to and from server 300. Server 300 receives external information 101 and transmits owner information 102, as well as receives information data 111 from power management unit 200 and transmits control data 112 to power management unit 200. Device group 400 is constituted by multiple types of devices, and transmits and receives data to and from power management unit 200.

From a functional view-point, server 300 has operational status managing part 301, deterioration diagnosis part 302, and high-value-added services part 303. Operational status managing part 301 manages operation or power consumption of each device within device group 400. For instance, if the device is a power generator, operational status managing part 301 manages a power generation amount of the device.

Deterioration diagnosis part 302 conducts deterioration diagnosis of each device within device group 400. If the device is a battery cell, deterioration diagnosis part 302 conducts deterioration diagnosis of the battery cell. If the device generates an alternating-current (AC) power, deterioration diagnosis part 302 conducts deterioration diagnosis from high-frequency data of the AC power. If the devise is a solar panel, deterioration diagnosis part 302 conducts deterioration diagnosis of the panel.

High-value-added services part 303 determines whether or not each device within device group 400 needs maintenance, and predicts the time when the maintenance is needed. Furthermore, high-value-added services part 303 conducts high-efficient energy management.

Note that, operational status managing part 301, deterioration diagnosis part 302, and high-value-added services part 303 are configurations from a functional view of server 300, but not a physical view.

External information 101 includes, for example, weather and disaster conditions, the presence or absence of construction work and a power failure, and a state of a transmission network. Server 300 acquires external information 101 periodically or as necessary. The information is converted into data, and then the data is transmitted to server 300 as data 113.

Owner information 102 corresponds to operational status of each device within device group 400, a prediction of maintenance time, information related to energy management consulting, and the like. Server 300 converts owner information 102 into data periodically or on demand, and transmits it to owners as data 114.

The devices constituting device group 400 are classified into, for example, a device for creating energy, a device for consuming energy, a device for accumulating energy, a device for converting energy, and a device for managing these devices related to the energy. Device group 400 is constituted by multiple different types of devices. The different types are two or more. Accordingly, device group 400 may be constituted by three types of devices, or may be constituted by two types of devices. Device group 400 may include a device for creating energy and a device for consuming energy. Device group 400 may include a device for creating energy and a device for accumulating energy. Device group 400 may include a device for consuming energy and a device for accumulating energy. Device group 400 may include a device for creating energy, a device for consuming energy, and a device for accumulating energy.

In the exemplary embodiment, device group 400 comprises of, for example, solar panel 411, maximum power point control device 412, diesel generator 413, AC-DC convertor 414, transmission network 415, switch 416, base station 417, battery managing system machine 418, lithium-ion battery 419, lead storage battery 420, voltage meter 421, switch 422, and transmission network repeater 423. The devices constituting device group 400 are not limited to these devices.

Solar panel 411 generates electric power by receiving sunlight. Maximum power point controller 412 extracts the electric power, which solar panel 411 generates, with high efficiency. Diesel generator 413 generates electric power by using a diesel engine. AC-DC converter 414 converts an alternating current generated by diesel generator 413 and an alternating current from transmission network 415 into a direct current. Transmission network 415 is a power system for conveying electricity. In this case, transmission network 415 includes a power system called a distribution network for conveying electricity from a distribution substation to each demand location, in addition to a power system for conveying electricity from a power plant to a power distribution substation. Switch 416 switches connection to AC-DC converter 414 from either diesel generator 413 or transmission network 415 electrically. Base station 417 is, for example, a base station of a mobile phone. Battery managing system machine 418 conducts management including control of charging and discharging lithium ion battery 419. Lithium-ion battery 419 is a rechargeable battery using lithium ions. Lead storage battery 420 is a rechargeable battery using lead. Voltage meter 421 measures the voltage of lead storage battery 420. Switch 422 selects whether either lithium-ion battery 419 or lead storage battery 420 is charged and discharged or neither lithium-ion battery 419 nor lead storage battery 420 are charged and discharged. Transmission network repeater 423 connects or cuts off transmission network 415.

Solar battery panel 411 and diesel generator 413 are devices for creating energy. Transmission network 415, itself, does not generate electric power, but it is categorized into a device for creating energy. This is because transmission network 415 is in common with a device for generating electricity from a view point of supplying energy. Base station 417 is a device for consuming energy. Lithium-ion batteries 419 and lead storage battery 420 are devices for accumulating energy. AC-DC converter 414 is a device for converting energy. Note that, the device for creating energy, which converts energy such as sunlight or light diesel oil into electric energy, differs from AC-DC convertor 414 in that it converts external energy of power management system 100 into internal energy of power management system 100. Therefore, the devices are classified as the above. Maximum power point control device 412, switch 416, battery managing system machine 418, voltage meter 421, switch 422, and the transmission network repeater 423 are devices for managing the other devices.

Note that, the devices each may be combined to constitute another device. For instance, solar panel 411 and maximum power point control device 412 are combined to constitute photovoltaic power generation unit 431. Battery managing system machine 418 and lithium-ion battery 419 are combined to constitute lithium-ion battery unit 432. Lead storage battery 420 and voltage meter 421 are combined to constitute lead storage battery unit 433.

Power management unit 200 receives panel deterioration data 451 and power generation data 452 from solar panel 411.

Power management unit 200 transmits and receives control and output data 453 to and from maximum power point control device 412.

Power management unit 200 receives high frequency data 454 from diesel generator 413, and transmits operation and stop data 455 to diesel generator 413. High frequency data 454 is data capable of measuring deterioration of diesel generator 413. As the deterioration of diesel generator 413 progresses, the vibration thereof is enlarged to increase high frequency components of the generated electric current. Thus, the deterioration status of diesel generator 413 can be noticed by using high frequency data 454. Operation and stop data 455 is control data that operates and stops diesel generator 413.

Power management unit 200 transmits switching data 456 to switch 416. According to switching data 456, switch 416 selects a device, which is to be connected to AC-DC convertor 414, from diesel generator 413 and transmission network 415.

Power management unit 200 transmits and receives control and output data 457 to and from AC-DC convertor 414.

Power management unit 200 transmits and receives power grid data 458 to and from transmission network repeater 423.

Power management unit 200 transmits and receives power control and operation status data 459 to and from base station 417.

Power management unit 200 transmits and receives storage status and battery degradation data 460 to and from battery managing system machine 418.

Power management unit 200 transmits switching data 461 to switch 422. According to switching data 461, switch 422 selects whether either lithium-ion battery 419 or lead storage battery 420 is charged and discharged or neither lithium-ion battery 419 nor lead storage battery 420 are charged and discharged.

Power management unit 200 receives battery degradation data 462 from lead storage battery 420.

Power management unit 200 receives voltage data 463 from voltage meter 421.

Power grid 480 is a conductor that connects between the devices, and transmits and receives electric power.

Note that, each device is allowed to transmit and receive status indication data and drive control data to and from the other devices as necessary.

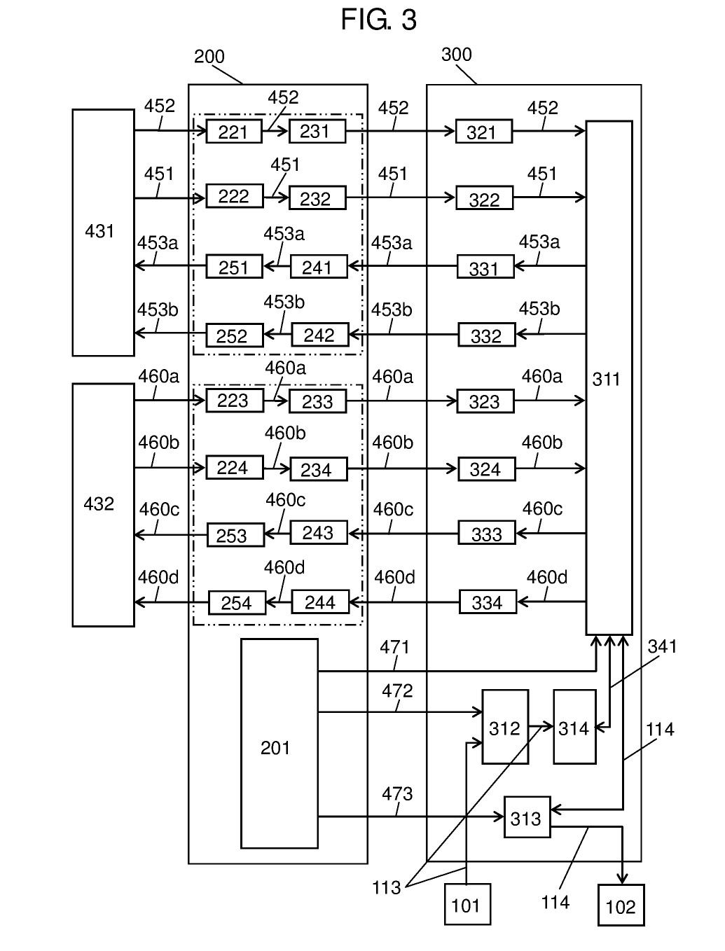

FIG. 3 is a block diagram of a power management system in the exemplary embodiment. In FIG. 3, photovoltaic power generation unit 431 and lithium-ion battery unit 432 will be described as exemplary devices.

Power management unit 200 has first information data receiving part 221 for receiving power generation data 452 from photovoltaic power generation unit 431, and first information data transmitting part 231 for transmitting the data to server 300. Power management unit 200 has second information data receiving part 222 for receiving panel deterioration data 451 from photovoltaic power generation unit 431, and second information data transmitting part 232 for transmitting the data to server 300.

Power management unit 200 has third information data receiving part 223 for receiving storage status data 460a from lithium-ion battery unit 432, and third information data transmitting part 233 for transmitting the data to server 300. Power management unit 200 has fourth information data receiving part 224 for receiving battery degradation data 460b from lithium-ion battery unit 432, and fourth information data transmitting part 234 for transmitting the data to server 300.

Power management unit 200 has first control data receiving part 241 for receiving power generation control data 453a related to photovoltaic power generation unit 431 from server 300, and first control data transmitting part 251 for transmitting the data to photovoltaic power generation unit 431.

Power management unit 200 has second control data receiving part 242 for receiving control data 453b (control data such as preventing panel deterioration) with respect to panel deterioration related to photovoltaic power generation unit 431 from server 300, and second control data transmitting part 252 for transmitting the data to photovoltaic power generation unit 431.

Power management unit 200 has third control data receiving part 243 for receiving charge control data 460c related to lithium-ion battery unit 432 from server 300, and third control data transmitting part 253 for transmitting the data to lithium-ion battery unit 432.

Power management unit 200 has fourth control data receiving part 244 for receiving control data 460d (control data such as preventing battery degradation) with respect to battery degradation related to lithium-ion battery unit 432 from server 300, and fourth control data transmitting part 254 for transmitting the data to lithium-ion battery unit 432.

As above, power management unit 200 receives data related to status of each device from the respective devices and transmits the data to server 300.

Power management unit 200 has controller 201. Controller 201 will be described later.

Server 300 has data processing part 311. Data processing part 311 obtains information from each device to produce control information for each device. More specifically, data processing part 311 firstly obtains operation status of an energy creation device, an energy accumulation device, an energy consumption device, an energy conversion device, and an energy management device based on data from the respective devices. Secondly, data processing part 311 calculates energy management information based on the operation status of the respective devices and external information 101. Data processing part 311 determines control patterns capable of using energy appropriately from the energy management information. The control patterns include, for example, ON/OFF, an amount of electric energy, switching time of each device, and a combination of these values. Data processing part 311 produces control information to be transmitted to power management unit 200 based on the determined control pattern.

Note that, data processing part 311 may produce control information based on information not only between different types of devices but also between the same type of devices. The control information is information for controlling each device.

Server 300 has first information data receiving part 321 for receiving receive power generation data 452, second information data receiving part 322 for receiving panel deterioration data 451, third information data receiving part 323 for receiving storage status data 460a, and fourth information data receiving part 324 for receiving battery degradation data 460b. These data are transmitted to data processing part 311.

Server 300 has first control data transmitting part 331 for transmitting power generation control data 453a transmitted from data processing part 311, second control data transmitting part 332 for transmitting control data 453b with respect to panel deterioration, third control data transmitting part 333 for transmitting charge control data 460c, and fourth control data transmitting part 334 for transmitting control data 460d with respect to battery degradation. These data are transmitted to power management unit 200.

Furthermore, server 300 has external information receiving part 312, management information transmitting part 313, and storage part 314.

External information receiving part 312 receives information update instruction 472 from controller 201 of power management unit 200 and receives data 113 in which external information 101 is converted into data. Storage part 314 stores data 113 received by external information receiving part 312 and data related to each device. At the time when data processing part 311 performs various calculations, storage part 314 transmits data 341, which is required for the calculations, to data processing part 311.

Management information transmitting part 313 receives information output instruction 473 from controller 201 and transmits data 114, in which owner information 102 is converted into data, to an owner.

Controller 201 periodically transmits information update instruction 472 and information output instruction 473 to server 300. Accordingly, data 113, in which external information 101 stored in storage part 314 is converted into data, is periodically updated. Data 114, in which owner information 102 is converted into data, is periodically transmitted to the owner. Data 114 is produced by data processing part 311 based on the status of each device or the like.

Note that, controller 201 may transmit information update instruction 472 and information output instruction 473 to server 300 as necessary.

Controller 201 causes data processing part 311 of server 300 to execute comparison instruction 471. When receiving comparison instruction 471, data processing part 311 compares the status of each device that is received from power management unit 200 with the information related to each device that is stored in storage part 314, and produces a control signal for controlling each device.

In this way, a power management unit includes a part that transmits a first information data and a second information data to a server. The first information data relates to a first device for creating, consuming, or accumulating first energy. The second information data relates to a second device for creating, consuming, or accumulating second energy. Further, the power management unit includes a part that receives control data for controlling the first device and the second device from the server, and a part that transmits the control data to the first device and the second device. A power management method is a way of transmitting first information data and second information data from the power management unit to the server. Further, the power management method is a way of transmitting control data for controlling the first device and the second device from the server to the power management unit, and transmits the control data from the power management unit to the first device and the second device. The power management unit and the power management method can control information related to multiple types of devices to utilize energy efficiently.

Power management unit 200 and power management system 100 including power management unit 200 operate as mentioned above, but not limited to the embodiment shown in FIG. 3. Various variations may be employed. Hereinafter, the variations will be described.

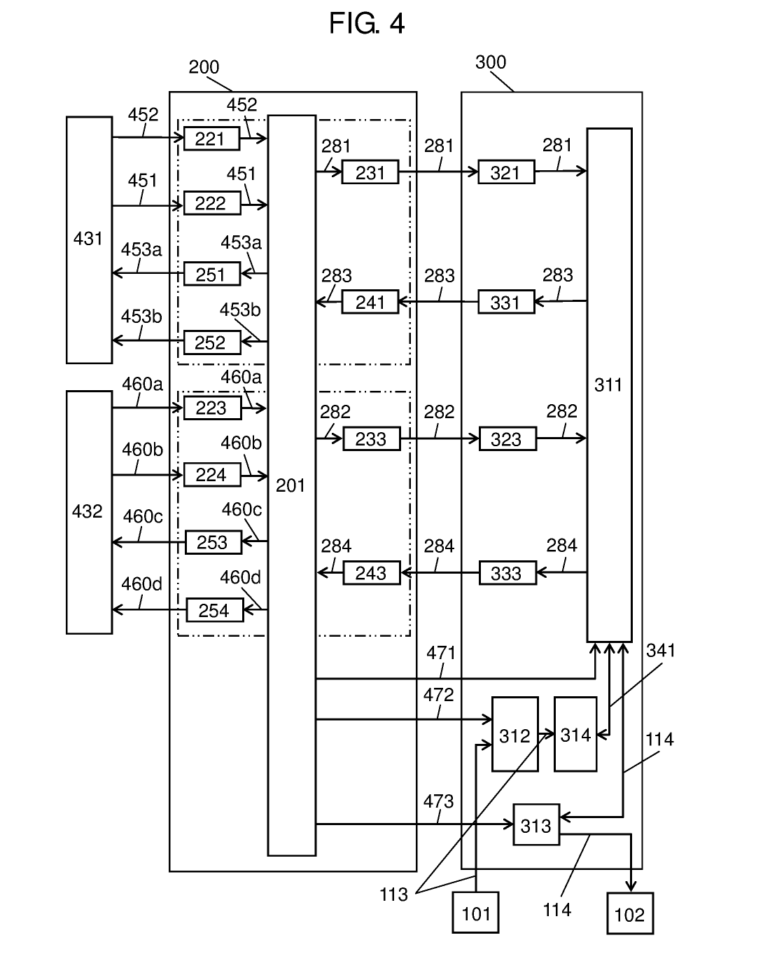

FIG. 4 is a block diagram of a power management system in a first variation of the exemplary embodiment. The difference from FIG. 3 is a way how to transmit and receive data between power management unit 200 and server 300. Power management unit 200 of FIG. 3 has parts for transmitting data to server 300 and parts for receiving data from server 300 data by data. On the other hand, in power management unit 200 of FIG. 4, the parts for transmitting data to server 300 are integrated into one part, and further the parts for receiving data from server 300 are integrated into one part device by device. Besides, transmission parts and receiving parts of server 300 are integrated device by device. Further, in power management unit 200 of FIG. 4, each data is transmitted and received through controller 201.

Hereinafter, the variation will be described practically.

The respective types of power generation data 452 and panel deterioration data 451 from photovoltaic power generation unit 431 are conveniently identified by controller 201 and transmitted to first information data transmitting part 231 as first device status data 281. First device status data 281 is transmitted from first information data transmitting part 231 to first information data receiving part 321 of server 300.

Likewise, the respective types of storage status data 460a and battery degradation data 460b from lithium-ion battery unit 432 are also identified by controller 201 conveniently and transmitted to third information data transmitting part 233 as second device status data 282. Second device status data 282 is transmitted from third information data transmitting part 233 to third information data receiving part 323 of server 300.

Control data to be transmitted to photovoltaic power generation unit 431 is transmitted from first control data transmission portion 331 of server 300 as first device control data 283, and received by first control data receiving part 241. After that, first device control data 283 is transmitted from first control data receiving part 241 to controller 201. If first device control data 283 is related to power generation control data, controller 201 transmits it to first control data transmitting part 251 as power generation control data 453a. If first device control data 283 is related to control data with respect to panel deterioration, controller 201 transmits it to second control data transmitting part 252 as control data 453b with respect to panel deterioration.

Likewise, control data to be transmitted to lithium-ion battery unit 432 is transmitted from third control data transmitting part 333 of server 300 as second device control data 284, and received by third control data receiving part 243. After that, second device control data 284 is transmitted from third control data receiving part 243 to controller 201. If second device control data 284 is related to charge control data, controller 201 transmits it to third control data transmitting part 253 as charge control data 460c. If second device control data 284 is related to control data with respect to battery degradation, controller 201 transmits it to fourth control data transmitting part 254 as control data 460d with respect to battery degradation.

Power management system 100 in the first variation integrates the transmission parts and the receiving parts to and from the server, device by device, thereby reducing the number of these parts.

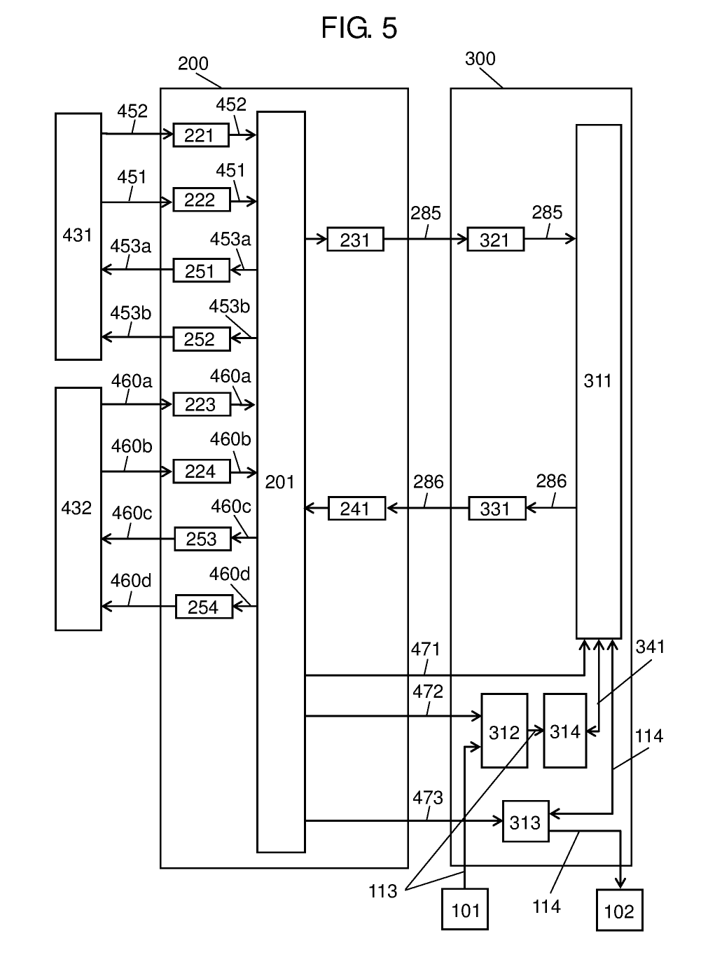

FIG. 5 is a block diagram of a power management system in a second variation of the exemplary embodiment. The difference from FIG. 4 is a way how to further integrate the transmission parts and the receiving parts which transmit and receive data between power management unit 200 and server 300. That is, the respective information data transmitted from photovoltaic power generation unit 431 and lithium-ion battery unit 432 are transmitted from first information data transmitting part 231 to first information data receiving part 321 as information data 285.

The respective control data to be transmitted to photovoltaic power generation unit 431 and lithium-ion battery unit 432 are transmitted from first control data transmission portion 331 to first control data receiving part 241 as control data 286.

The power management system in the second variation shown in FIG. 5 is operated based on the power management system in first variation shown in FIG. 4. In the power management system in the first variation of FIG. 4, controller 201 is needed to identify which information it is, and then to operate according to the identification result. In addition to this, the power management system in the second variation shown in FIG. 5 identifies which device data it is, and then operates according to the identification result.

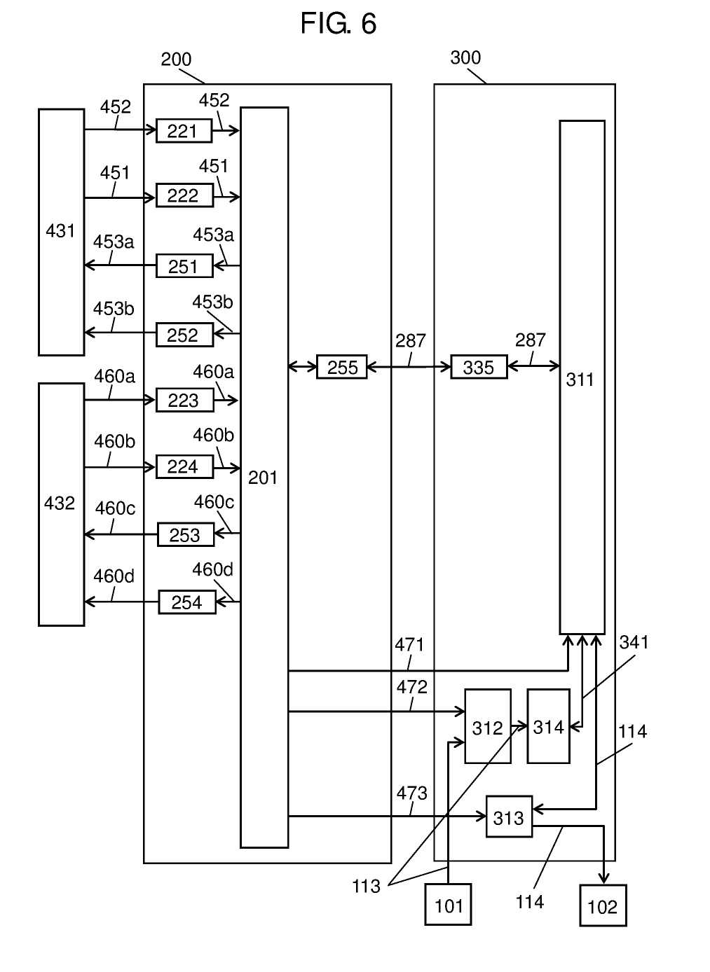

FIG. 6 is a block diagram of a power management system in a third variation of the exemplary embodiment. The power management system in the third variation shown in FIG. 6 is based on the power management system in the second variation shown in FIG. 5. To transmit and receive data between power management unit 200 and server 300, In the power management system in the second variation shown in FIG. 5, power management unit 200 has first information data transmitting part 231 and first control data receiving part 241. Thus, first information data transmitting part 231 transmits data and first control data receiving part 241 receives data individually. On the other hand, power management unit 200 in a fourth variation shown in FIG. 6 transmits and receives data 287 to and from server 300 by data transmission and receiving part 255. Server 300 transmits and receives data 287 to and from power management unit 200 by transmission and receiving part 335.

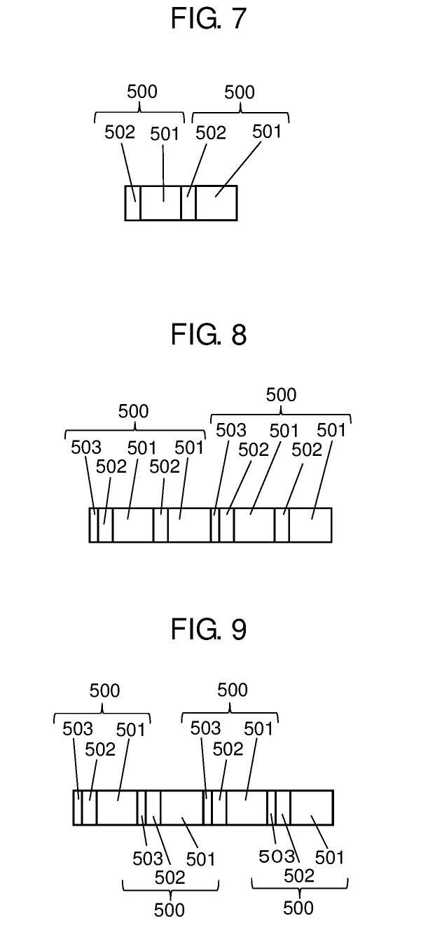

FIG. 7 is a view showing a data configuration in the first variation of the exemplary embodiment.

Unitary data 500 has data signal 501 and data type signal 502. Data signal 501 is a signal in which information to be conveyed is converted into a signal. For instance, a voltage value and a generation power value are corresponded. Data type signal 502 is a signal for identifying what type of information is conveyed. The type of information is, for example, voltage, panel deterioration, generation power, and the like. Unitary data 500, which indicates what type of information is conveyed, is employed when data is transmitted and received between power management unit 200 in the first variation shown in FIG. 4 and server 300. That is, first device status data 281, second device status data 282, first device control data 283, and second device control data 284 are transmitted and received in a unitary data 500 format shown in FIG. 7.

FIG. 8 is a view showing a data configuration in the second variation of the exemplary embodiment.

Unitary data 500 has device identification signal 503, multiple data signals 501, and multiple data type signals 502.

Data signals 501 and data type signals 502 are the same as the data configuration in the first variation shown in FIG. 7. Device identification signal 503 indicates which device information it is.

In unitary data 500, device identification signal 503 indicates a device, and data type signal 502 indicates what type of data it is. Data signals 501 and data type signals 502 are paired. Device identification signal 503 is added to multiple pairs of data signals 501 and data type signals 502.

Since unitary data 500 shown in FIG. 8 indicates which device signal it is, it is employed when data is transmitted and received between power management unit 200 in the second variation shown in FIG. 5 and server 300. That is, unitary data 500 shown in FIG. 8 is used for information data 285 and control data 286.

Note that, unitary data 500 shown in FIG. 8 may also be employed when data is transmitted and received between power management unit 200 in the third variation shown in FIG. 6 and server 300. If a type of signal that corresponds to one device is single, the signal has a data configuration shown in FIG. 9 described later.

FIG. 9 is a view showing another type of data configuration in the second variation of the exemplary embodiment. Unitary data 500 has data signal 501, data type signal 502, and device identification signal 503 one by one. The another type of data configuration in the second variation of the exemplary embodiment shown in FIG. 9 is employed when data is transmitted and received between power management unit 200 in the second variation shown in FIG. 5 or the third variation shown in FIG. 6 and server 300.

Note that, the data configurations shown in FIGS. 7 to 9 are produced and decoded by controller 201 and data processing part 311.

### FIRST REFERENCE EXAMPLE

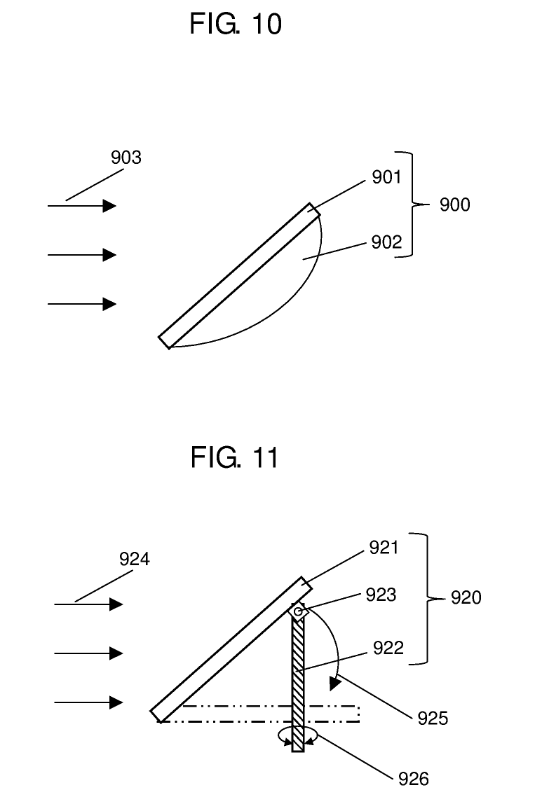

FIG. 10 is a schematic view of a solar panel unit in a first reference example.

Solar panel unit 900 has solar panel 901 and wind guard 902.

Solar panel 901 converts solar light energy into electric energy. Wind guard 902 is attached to a back side surface of solar panel 901. The back side surface of solar panel 901 is a surface directed to a ground side when plat solar panel 901 is installed. Wind guard 902 has a streamline shape.

Wind guard 902 prevents wind 903 from causing a turbulent flow on the back side surface of solar panel 901.

### SECOND REFERENCE EXAMPLE

FIG. 11 is a schematic view of a solar panel unit in a second reference example.

Solar panel unit 920 has solar panel 921, support column 922, and shaft 923.

Solar panel 921 converts solar light energy into electric energy. Support column 922 rotatably holds solar panel 921 through shaft 923 as shown by arrow 925. A tow-dot chain line in FIG. 11 indicates a position when solar panel 921 is turned, i.e., a position when solar panel 921 is tilted horizontally. At this time, support column 922 moves downward. Solar panel 921 can move in both directions from the horizontal position illustrated by the two-dot chain line to the position illustrated by a solid line. Support column 922 is rotatable as shown by arrow 926.

If wind 924 is strong, solar panel 921 is tilted horizontally to reduce the resistance of wind 924. In the case where a wind power generator is installed near solar panel 921, the angle of solar panel 921 can be changed by using generation power of the wind power generator.

The solar panel unit in the first reference example and the second reference example prevents destruction or breakages of a solar panel installed on an upper side of a street light, a street lamp, and the like.

### INDUSTRIAL APPLICABILITY

According to the power management unit and the power management method of the present disclosure, information related to multiple types of devices can be controlled to utilize energy efficiently. Thus, the power management unit and the power management method are useful.

### REFERENCE MARKS IN THE DRAWINGS

100 power management system
101 external information
102 owner information
111 information data
112 control data
113,114 data
200 power management unit
201 controller
221 first information data receiving part
222 second information data receiving part
223 third information data receiving part
224 fourth information data receiving part
231 first information data transmitting part
232 second information data transmitting part
233 third information data transmitting part
234 fourth information data transmitting part
241 first control data receiving part
242 second control data receiving part
243 third control data reception site
244 fourth control data receiving part
251 first control data transmitting part
252 second control data transmitting part
253 third control data transmitting part
254 fourth control data transmitting part
255 data transmission and receiving part
281 first device status data
282 second device status data
283 first device control data
284 second device control data
285 information data
286 control data
287 data
300 server
301 operational status managing part
302 deterioration diagnosis part
303 high-value-added services part
311 data processing part
312 external information receiving part
313 management information transmitting part
314 storage part
321 first information data receiving part
322 second information data receiving part
323 third information data receiving part
324 fourth information data receiving part
331 first control data transmitting part
332 second control data transmitting part
333 third control data transmitting part
334 fourth control data transmitting part
335 transmission and receiving part
341 data
400 device group
411 solar panel
412 maximum power point control device
413 diesel generator
414 AC-DC convertor
415 transmission network
416 switch
417 base station
418 battery managing system machine
419 lithium-ion battery
420 lead storage battery
421 voltage meter
422 switch
423 transmission network repeater
431 photovoltaic power generation unit
432 lithium-ion battery unit
433 lead storage battery unit
451 panel deterioration data
452 power generation data
453 control and output data
453a generation control data
453b control data with respect to panel deterioration
454 high frequency data
455 operation and stop data
456 switching data
457 control and output data
458 transmission network data
459 power control and operation status data
460 storage status and battery degradation data
460a storage status data
460b battery degradation data
460c charge control data
460d control data with respect to battery degradation
461 switching data
462 battery degradation data
463 voltage data
471 comparison instruction
472 information update instruction
473 information output instruction
480 power grid
500 unit data
501 data signal
502 data type signal
503 device identification signal
900 solar panel unit
901 solar panel
902 wind guard
903 wind
920 solar panel unit
921 solar panel
922 support column
923 shaft
924 wind
925,926 arrow

1. A power management unit comprising:
a first transmission part that transmits a first information data related to a first device for creating, consuming, or accumulating first energy and a second information data related to a second device for creating, consuming, or accumulating second energy to a server;
a first receiving part that receives control data for controlling the first device and the second device from the server; and
a second transmission part that transmits the control data to the first device and the second device.

2. The power management unit according to claim 1, wherein
the first device and the second device are any of a solar panel, a diesel generator, transmission network, a base station, a lead storage battery, and a lithium-ion battery.

3. The power management unit according to claim 1, wherein
the control data is obtained by comparison processing in which information held by the server is compared with the first information data and the second information data.

4. The power management unit according to claim 3, further comprising
a part that transmits instructions for causing the server to perform the comparison processing.

5. The power management unit according to claim 1, wherein
update processing is periodically performed on information held by the server.

6. The power management unit according to claim 5, further comprising
a part that transmits instructions for causing the server to perform the update processing to the server.

7. The power management unit according to claim 5, wherein
external information updated periodically includes information related to weather, a disaster, construction work, a power failure, or a state of transmission network.

8. The power management unit according to claim 1, wherein
each of the first information data and the second information data includes any of power generation data, operation status data, charge status data, and battery degradation data.

9. The power management unit according to claim 1, wherein
the first information data is data related to creating the first energy by the first device, and
the second information data is data related to consuming the second energy by the second device.

10. The power management unit according to claim 1, wherein
the first information data is data related to creating the first energy by the first device, and
the second information data is data related to accumulating the second energy by the second device.

11. The power management unit according to claim 1, wherein
the first information data is data related to consuming the first energy by the first device, and
the second information data is data related to accumulating the second energy by the second device.

12. The power management unit according to claim 1, wherein
the first transmission part that transmits the first information data and the second information data to the server further transmits third information data related to a third device for creating, consuming, or accumulating third energy to the server,
the control data further includes data for controlling the third device,
the second transmission part that transmits the control data to the first device and the second device further transmits the control data to the third device,
the first information data is data related to creating the first energy by the first device,
the second information data is data related to consuming the second energy by the second device, and
the third information data is data related to accumulating the third energy by the third device.

13. A power management method comprising:
transmitting first information data related to a first device for creating, consuming, or accumulating first energy and second information data related to a second device for creating, consuming, or accumulating second energy from a power management unit to a server,
transmitting control data for controlling the first device and the second device from the server to the power management unit, and
transmitting the control data from the power management unit to the first device and the second device.
